(19) United States
(12) Patent Application Publication
(10) Pub. No.: US 2026/0365194 A1
(43) Pub. Date: Nov. 19, 2026

(54) DRIVING ASSISTANCE DEVICE

(71) Applicant: TOYOTA JIDOSHA KABUSHIKI KAISHA, Toyota-shi (JP)

(72) Inventor: Chiemi SEKIGUCHI, Toyota-shi (JP)

(73) Assignee: TOYOTA JIDOSHA KABUSHIKI KAISHA, Toyota-shi (JP)

(21) Appl. No.: 19/544,059

(22) Filed: Feb. 19, 2026

(30) Foreign Application Priority Data
May 15, 2025 (JP) 2025-081659

(51) Int. Cl. B60W 50/14; B60W 30/12; B60W 40/09; G06V 20/59

(52) U.S. Cl. CPC B60W 50/14; B60W 30/12; B60W 40/09; G06V 20/597; B60W 2050/143; B60W 2050/146; B60W 2420/403; B60W 2540/225; B60W 2556/10

(57) ABSTRACT

The driving assistance device comprises a driver sensor that acquires gaze information that is information on a gaze direction of the driver. The processor is configured to, at a first point in time at which the first condition is satisfied, execute skip processing of skipping the alarm processing in a case where: an elapsed time from a point in time at which a second condition for determining that the behavior of the host vehicle is unstable is last satisfied, based on a history of the target information and/or the vehicle information, exceeds a threshold value; and a third condition for determining that the driver visually confirms safety in the vicinity within a predetermined period immediately before the first point in time is satisfied, based on a history of the gaze information.

### CROSS-REFERENCE TO RELATED APPLICATION

This application claims priority to Japanese Patent Application No. 2025-081659 filed on May 15, 2025. The disclosure of the above-identified application, including the specification, drawings, and claims, is incorporated by reference herein in its entirety.

### BACKGROUND

### 1. Technical Field

The present disclosure relates to a driving assistance device that has a function of suppressing departure of the host vehicle from a lane in which the host vehicle is traveling.

### 2. Description of Related Art

A driving assistance device that has a function of suppressing departure of the host vehicle from a lane in which the host vehicle is traveling has been proposed (for example, see Japanese Unexamined Patent Application Publication No. 2008-269399 (JP 2008-269399 A)). The device (hereinafter, referred to as the “conventional device”) includes a camera and a processor. The processor executes alarm processing of controlling a notification device to issue a predetermined alarm to the driver of the host vehicle in a case where the processor determines, based on an image acquired by the camera, that there is a high possibility that the host vehicle departs from the lane in which the host vehicle is traveling.

Meanwhile, a scene in which the driver intentionally causes the host vehicle to depart from the lane (for example, a lane change) is assumed. In the scene, the driver may feel that the alarm is bothersome. Therefore, the conventional device has a function of, in a case where a deviation between gaze of the driver and a traveling direction of the host vehicle is equal to or less than a threshold value, assuming that the driver has an intention to cause the host vehicle to depart from the lane and skipping the alarm processing.

### SUMMARY

Even in a case where a gaze direction of the driver of the host vehicle and the traveling direction of the host vehicle are substantially the same, the driver may be inattentive. The processor of the conventional device skips the alarm processing even in the scene. Therefore, the driver may unintentionally cause the host vehicle to depart from the lane.

An object of the present disclosure is to provide a driving assistance device that can improve the safety of the host vehicle and a pedestrian in the vicinity of the host vehicle.

In order to achieve the object, a driving assistance device (1) according to the present disclosure includes:
a peripheral sensor (21) configured to acquire target information that is information on a target located around a host vehicle (V0);
a vehicle sensor (22, 23) configured to acquire vehicle information that is information on behavior of the host vehicle; and
a processor (10) configured to execute, based on the target information and the vehicle information, alarm processing of controlling a notification device (30) of the host vehicle to issue a predetermined alarm to a driver of the host vehicle in a case where a first condition (X) for determining that there is a high possibility that the host vehicle departs from a lane in which the host vehicle is traveling is satisfied.

The driving assistance device further includes a driver sensor (24) configured to acquire gaze information that is information on gaze of the driver.

The processor is configured to execute, at a first point in time (t0) at which the first condition is satisfied, skip processing of skipping the alarm processing in a case where
the processor acquires an elapsed time (Δt) from a point in time at which a second condition (Y1, Y2) for determining, based on a history of either or both of the target information and the vehicle information, that the behavior of the host vehicle is unstable has been satisfied most recently, and the elapsed time exceeds a threshold value (Δtth), and
a third condition (ZL, ZR) for determining, based on a history of the gaze information, that the driver has visually confirmed safety in a surrounding area within a predetermined period immediately before the first point in time is satisfied.

The processor of the driving assistance device according to the present disclosure executes the alarm processing in a case where there is a high possibility that the host vehicle departs from the lane in which the host vehicle is traveling. However, even in a situation where there is a high possibility that the host vehicle departs from the lane in which the host vehicle is traveling, the processor skips the alarm processing in the following case, that is, a case where a certain amount of time has elapsed after the behavior of the host vehicle has been stabilized, and the driver has confirmed the safety in the surrounding area. That is, in a situation where the behavior of the host vehicle is unstable or immediately after the situation is resolved, and where the driver has not confirmed the safety in the surrounding area, the processor executes the alarm processing as a matter of principle. Therefore, according to the present disclosure, the safety of the host vehicle and the safety in the surrounding area can be maintained at a high level in a situation with a high possibility that the driver does not intend for the host vehicle to depart from the lane.

In the driving assistance device according to one aspect of the present disclosure,
the processor is configured to determine, based on the gaze information, that the third condition is satisfied in a case where the processor detects that a first safety confirmation has been performed by the driver visually checking a predetermined mirror of the host vehicle and a second safety confirmation has been performed by the driver directly visually checking a blind spot region that is a region that is not reflected in the mirror.

In a case where only one of the first safety confirmation by the driver visually checking the mirror of the host vehicle and the second safety confirmation by the driver visually checking the blind spot region of the mirror is performed, sufficient confirmation of the safety of the host vehicle and the safety in the surrounding area is difficult. In the driving assistance device according to the present aspect, in a case where the first safety confirmation and the second safety confirmation are performed, determination is made that the safety of the host vehicle and the safety in the surrounding area are confirmed. As a result, the safety of the host vehicle and the safety in the surrounding area when the alarm processing is skipped are maintained at a high level.

In the driving assistance device according to another aspect of the present disclosure,
the vehicle sensor includes a driving operation sensor configured to output a value corresponding to a driving operation, the vehicle sensor being provided in a driving operation device, and
the processor is configured to determine, based on a history of the value acquired from the driving operation sensor, that the second condition is satisfied in a case where a rate of change of the value exceeds a predetermined value.

As a result, the processor can relatively easily determine whether the behavior of the host vehicle is unstable.

In the driving assistance device according to still another aspect of the present disclosure,
the processor is configured to determine, based on either or both of the target information and the vehicle information, that the second condition is satisfied in a case where the number of times that a lateral movement direction of the host vehicle is reversed within a predetermined period immediately before a current point in time exceeds a predetermined number of times.

As a result, for example, in a case where the driver is undecided about route selection, the alarm processing is executed. In addition, for example, in a scene where the host vehicle is meandering due to a decreased level of consciousness of the driver, the alarm processing is executed in a case where there is a high possibility that the host vehicle departs from the lane in which the host vehicle is traveling. As a result, the safety of the host vehicle and the safety in the surrounding area are maintained at a high level.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a driving assistance device according to an embodiment of the present disclosure;

FIG. 2 is a plan view showing an example of detecting that the driver visually checks a right side view mirror based on an image acquired by the driver sensor;

FIG. 3 is a plan view showing a direction (angle range) of a right-side blind spot region;

FIG. 4 is a graph showing a change in a steering angle;

FIG. 5 is a flowchart of a first program executed by a CPU to implement an alarm function; and

FIG. 6 is a flowchart of a second program executed by the CPU to implement the alarm function.

### DETAILED DESCRIPTION OF EMBODIMENTS

### Summary

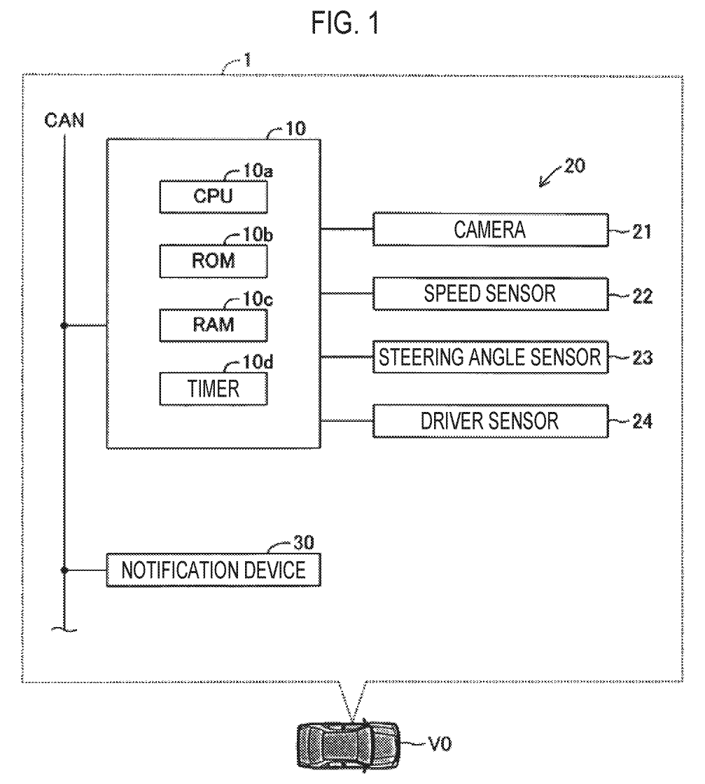

As shown in FIG. 1, a driving assistance device 1 according to the embodiment of the present disclosure is applied to a vehicle V0. The vehicle V0 (hereinafter, referred to as the “host vehicle”) includes an automated driving function. The driving assistance device 1 includes a function (alarm function) of issuing a predetermined alarm to the driver of the host vehicle in a case where the automated driving function of the host vehicle is disabled and the driver is executing a manual driving operation, and the host vehicle is likely to depart from a lane L in which the host vehicle is traveling.

### Specific Configuration

Next, a configuration of the driving assistance device 1 will be specifically described. As shown in FIG. 1, the driving assistance device 1 includes an ECU 10, a vehicle-mounted sensor 20, and a notification device 30.

The ECU 10 includes a microcomputer including a CPU 10a, a ROM 10b, a RAM 10c, a timer 10d, and the like. The ECU 10 is connected to other ECUs via a communication network (CAN).

The vehicle-mounted sensor 20 includes a camera 21 as a peripheral sensor for acquiring information on a target located around the host vehicle. In addition, the vehicle-mounted sensor 20 includes a speed sensor 22 and a steering angle sensor 23 as a vehicle sensor for acquiring information on the behavior of the host vehicle. Further, the vehicle-mounted sensor 20 includes a driver sensor 24 for detecting a gaze direction of the driver.

The camera 21 includes an imaging device. The imaging device incorporates, for example, an imaging element such as a charge-coupled device (CCD) or a CMOS image sensor (CIS). Each imaging device is installed, for example, on a front portion, a right side portion, a left side portion, and a rear portion of the host vehicle. The imaging device captures an image of a peripheral region of the host vehicle at a predetermined frame rate to acquire image data. The camera 21 further includes an image analysis device. The image analysis device sequentially acquires the image data from each imaging device. The image analysis device analyzes the acquired image data to acquire information on a target located around the host vehicle from the image. For example, the image analysis device identifies a pair of white lines on the left and right that partition the lane in which the host vehicle is traveling and another lane. For example, the image analysis device provides coordinates of a position of the white line (for example, an end point (an end point on a side close to the host vehicle and an end point on a side far from the host vehicle) in an extending direction of each white line in the image) as the target information to the ECU 10.

The speed sensor 22 detects a rotation speed (wheel speed) of each wheel and calculates a speed sp0 (measured value) of the host vehicle based on each wheel speed. The speed sensor 22 provides the calculation result to the ECU 10.

The steering angle sensor 23 detects a steering angle θ of a steering wheel of the host vehicle and provides the detection result to the ECU 10.

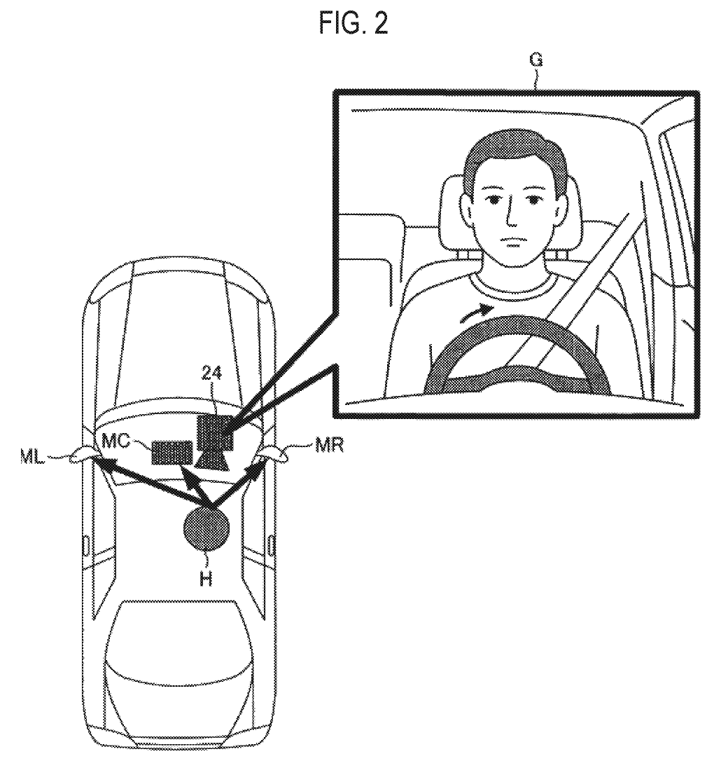

The driver sensor 24 includes an in-vehicle camera. The in-vehicle camera includes an imaging device. For example, as shown in FIG. 2, the imaging device is installed in an instrument panel and is directed rearward (headrest of the driver's seat). The imaging device captures an image G of a head H of the driver at a predetermined frame rate. The imaging device provides the acquired image G to the ECU 10.

The notification device 30 includes an image display device and an audio device. The image display device acquires an image display command from the ECU 10 and displays the image in response to the command. The audio device acquires a voice playback command from the ECU 10 and plays back a voice in response to the command.

### Alarm Function

The ECU 10 calculates a lateral position of the host vehicle in the lane L in which the host vehicle is traveling, based on the coordinates of the white line acquired from the camera 21. An example of the lateral position is a lateral distance ΔDR between a right end part of a front surface of the host vehicle and a right-side white line and a lateral distance ΔDL between a left end part of the front surface and a left-side white line. The ECU 10 sequentially determines whether a following condition X related to the lateral distance ΔDR and the lateral distance ΔDL is satisfied.

Condition X: any one of the lateral distance ΔDR or the lateral distance ΔDL is equal to or less than a threshold value ΔDth.

In a case where the condition X is satisfied, the ECU 10 executes alarm processing of controlling the notification device 30 to issue a predetermined alarm to the driver. That is, the ECU 10 transmits a command to display a predetermined image indicating that the host vehicle is likely to depart from the lane L to the image display device of the notification device 30. In addition, the ECU 10 transmits a command to play back a predetermined voice indicating that the host vehicle is likely to depart from the lane L to the audio device of the notification device 30.

Here, a scene is assumed in which the driver intentionally executes a driving operation for a lane change after confirming the safety in the vicinity. In a case where the above-described alarm is issued in this scene, the driver may feel that the alarm is bothersome. Therefore, it is preferable to skip the alarm processing in this scene. However, in a case where the behavior of the host vehicle is unstable, it is preferable not to skip the above-described alarm processing from the viewpoint of the safety of the host vehicle and the pedestrian in the vicinity thereof. In addition, for example, from the viewpoint of the safety of the host vehicle and the pedestrian in the vicinity thereof, it is preferable not to skip the above-described alarm processing immediately after a collision avoidance action or in a case where the level of consciousness of the driver is decreased (including immediately after the level of consciousness is recovered). In addition, from the viewpoint of the safety of the host vehicle and the pedestrian in the vicinity thereof, it is preferable not to skip the above-described alarm processing in a case where the driver does not confirm the safety in the vicinity before the lane change.

Therefore, as will be described below, the ECU 10 executes first determination processing and second determination processing at a point in time t0 at which it is determined that the condition X is satisfied. The first determination processing determines whether a sufficient amount of time has elapsed after the behavior of the host vehicle has been stabilized. The second determination processing determines whether the driver has confirmed the safety in the vicinity within a predetermined period immediately before the point in time t0. Then, the ECU 10 determines whether to execute the above-described alarm processing (whether to skip the alarm processing) based on the results of these processes. The execution order of the first determination processing and the second determination processing is not limited.

### Preprocessing of First Determination Processing

In order to determine whether a sufficient amount of time has elapsed after the behavior of the host vehicle has been stabilized, the ECU 10 executes the following process as the preprocessing. That is, the ECU 10 always monitors whether the behavior of the host vehicle is unstable. The ECU 10 measures an elapsed time Δt from a point in time at which the behavior of the host vehicle was last determined to be unstable (a point in time at which a transition of the behavior of the host vehicle from the unstable state to the stable state occurred). Specifically, the ECU 10 sequentially acquires the steering angle θ from the steering angle sensor 23 and stores the steering angle θ in the RAM 10c as steering angle history data. In addition, the ECU 10 sequentially acquires the speed sp0 from the speed sensor 22 and stores the speed sp0 in the RAM 10c as speed history data. The ECU 10 acquires an aspect of a change in the steering angle θ of the host vehicle in a predetermined length period T1 immediately before the current point in time based on the steering angle history data stored in the RAM 10c. In addition, the ECU 10 acquires an aspect of the change in the speed sp0 in the period T1 based on the speed history data. The ECU 10 sequentially determines whether the following conditions Y1, Y2 are satisfied based on the aspects of the changes in the steering angle θ and the speed sp0 in the period T1.

Condition Y1: the number of times N of a reversal of a movement direction of the host vehicle in the lateral direction in the period T1 exceeds a threshold value Nth.

Condition Y2: a lateral movement speed spy of the host vehicle exceeds a threshold value spyth.

For example, the condition Y1 is likely to be satisfied in a case where the driver is undecided about the route selection or in a case where the level of consciousness is decreased (drowsy driving). In addition, for example, in a case where the steering wheel is rotated significantly to avoid a collision with a pedestrian who suddenly ran out in front of the host vehicle, the condition Y2 is likely to be satisfied. The condition Y1 may be defined such that the condition Y1 is satisfied in a case where the number of times of a transition from a state in which the absolute value of the steering angle θ is equal to or less than a predetermined value to a state in which the absolute value of the steering angle θ exceeds the predetermined value in the period T1 exceeds the threshold value.

The ECU 10 determines that the behavior of the host vehicle is unstable in a case where at least one of the condition Y1 or the condition Y2 is satisfied. The ECU 10 always operates the timer 10d as a count-up timer, and resets (sets to “0”) the output of the timer 10d each time the condition Y1 or the condition Y2 is satisfied. As a result, the time Δt ( = output of the timer 10d) elapsed from the point in time at which the behavior of the host vehicle was last determined to be unstable is measured.

### First Determination Processing

The ECU 10 acquires the time Δt from the timer 10d at the point in time t0. The ECU 10 determines that a sufficient amount of time has elapsed after the behavior of the host vehicle has been stabilized in a case where the time Δt exceeds a threshold value Δtth (for example, 10 minutes).

### Preprocessing of Second Determination Processing

The ECU 10 executes the following process as the preprocessing for determining whether the driver has confirmed the safety in the vicinity before the lane change. That is, the ECU 10 specifies a head region of the driver in the image G and acquires (estimates) a head posture (three-dimensional information) based on a feature point (landmark) of the head H. Here, in the head posture estimation, the ECU 10 uses, for example, a perspective-n-point (PnP) algorithm. That is, the ECU 10 calculates a rotation angle (pitch, yaw, roll) of the head H based on a three-dimensional face model defined in advance and the corresponding points on the image G. Next, the ECU 10 specifies a pupil region in an eyeball region of the driver in the image G and estimates an orientation of an eyeball E with respect to an orientation of the head H. Then, the ECU 10 combines both the head direction and the eyeball direction to acquire the gaze direction as a three-dimensional vector (pitch, yaw, and roll as angle components), and stores the data (gaze data) in the RAM 10c. Here, in the pupil region estimation, the ECU 10 can use edge detection based on a brightness gradient or a pupil center corneal reflection (PCCR) method using infrared illumination. The ECU 10 may directly estimate the gaze direction from the image G using a trained model (for example, GazeNet, iTracker, or the like) including a convolutional neural network (CNN).

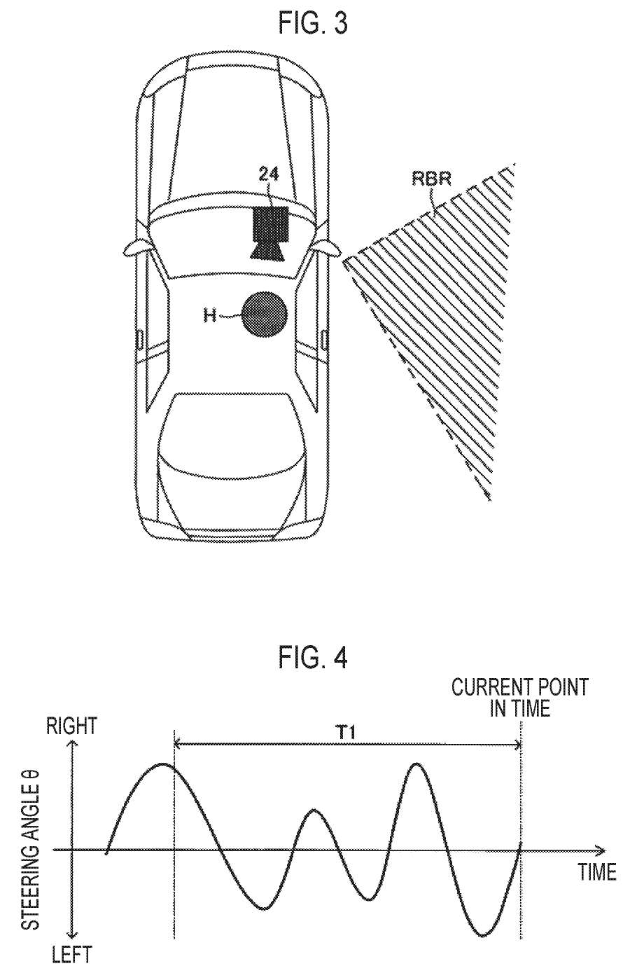

Meanwhile, an installation position of the in-vehicle camera constituting the driver sensor 24 and an orientation (optical axis direction) of a lens of the in-vehicle camera are fixed. In addition, various mirrors are provided in the host vehicle, but the installation positions thereof are fixed. Therefore, it is possible to determine whether the driver visually checks the mirror based on the data indicating the positional relationship between the in-vehicle camera and the various mirrors and the gaze data (three-dimensional vector). In addition, the ECU 10 can determine whether the driver visually checks a direction (for example, an angle range with oblique lines in FIG. 3) of a blind spot region that is a region not reflected in the mirror in a side and rear region of the host vehicle based on the data. Specifically, the ECU 10 determines that the driver visually checks a rearview mirror MC in a case where the gaze of the driver specified by the gaze data (components of the three-dimensional vector) is included in a predetermined angle range RMC corresponding to the rearview mirror (in-vehicle mirror) MC. In addition, the ECU 10 determines that the driver visually checks a left side view mirror (left side outside mirror) ML in a case where the gaze of the driver specified by the gaze data is included in a predetermined angle range RML corresponding to the left side view mirror ML. In addition, the ECU 10 determines that the driver visually checks a right side view mirror (right side outside mirror) MR in a case where the gaze of the driver specified by the gaze data is included in a predetermined angle range RMR corresponding to the right side view mirror MR. In addition, the ECU 10 determines that the driver visually checks a left-side blind spot region in a case where the gaze of the driver specified by the gaze data is included in a predetermined angle range RBL corresponding to the left-side blind spot region. In addition, the ECU 10 determines that the driver visually checks a right-side blind spot region in a case where the gaze of the driver specified by the gaze data is included in a predetermined angle range RBR corresponding to the right-side blind spot region. In a case where the driver finely adjusts the orientation of the various mirrors, the ECU 10 changes the predetermined angle ranges RMC, RML, RMR, RBR, and RBL in accordance with the adjustment amount.

### Second Determination Processing

The ECU 10 determines whether the driver has confirmed the safety in the vicinity within a predetermined period T2 (for example, 3 seconds) immediately before the point in time t0 based on a history (trajectory of the gaze) of the gaze data at the point in time t0. Specifically, the ECU 10 determines whether the following condition ZL is satisfied at the point in time t0 in a case where the lateral distance ΔDL is equal to or less than the threshold value ΔDth (in a case where the host vehicle approaches a left end of the lane L). On the other hand, the ECU 10 determines whether the following condition ZR is satisfied at the point in time t0 in a case where the lateral distance ΔDR is equal to or less than the threshold value ΔDth (in a case where the host vehicle approaches a right end of the lane L).

Condition ZL: first safety confirmation of visually checking the rearview mirror and the left side view mirror and second safety confirmation of visually checking the left-side blind spot region are performed by the driver in the period T2.

Condition ZR: first safety confirmation of visually checking the rearview mirror and the right side view mirror and second safety confirmation of visually checking the right-side blind spot region are performed by the driver in the period T2.

The ECU 10 acquires a history (change in the three-dimensional vector) of the gaze data in the period T2 based on the history of the gaze data. The ECU 10 determines that the condition ZL is satisfied in a case where the gaze of the driver is included in each of the angle ranges RMC, RML, and RBL at least once (order is not limited) in the period T2. That is, in this case, the ECU 10 regards the driver as having confirmed the safety on the left side and the rear side. On the other hand, the ECU 10 determines that the condition ZR is satisfied in a case where the gaze of the driver is included in each of the angle ranges RMC, RMR, and RBR at least once (order is not limited). That is, in this case, the ECU 10 regards the driver as having confirmed the safety on the right side and the rear side.

### Alarm Skip Processing

The ECU 10 may determine at the point in time t0 that the lateral distance ΔDL is equal to or less than the threshold value ΔDth, a sufficient amount of time has elapsed after the behavior of the host vehicle has been stabilized, and the driver has confirmed the safety on the left side and the rear side. In this case, the ECU 10 skips the above-described alarm processing. On the other hand, the ECU 10 may determine that the lateral distance ΔDR is equal to or less than the threshold value ΔDth, a sufficient amount of time has elapsed after the behavior of the host vehicle has been stabilized, and the driver has confirmed the safety on the right side and the rear side. In this case, the ECU 10 skips the above-described alarm processing.

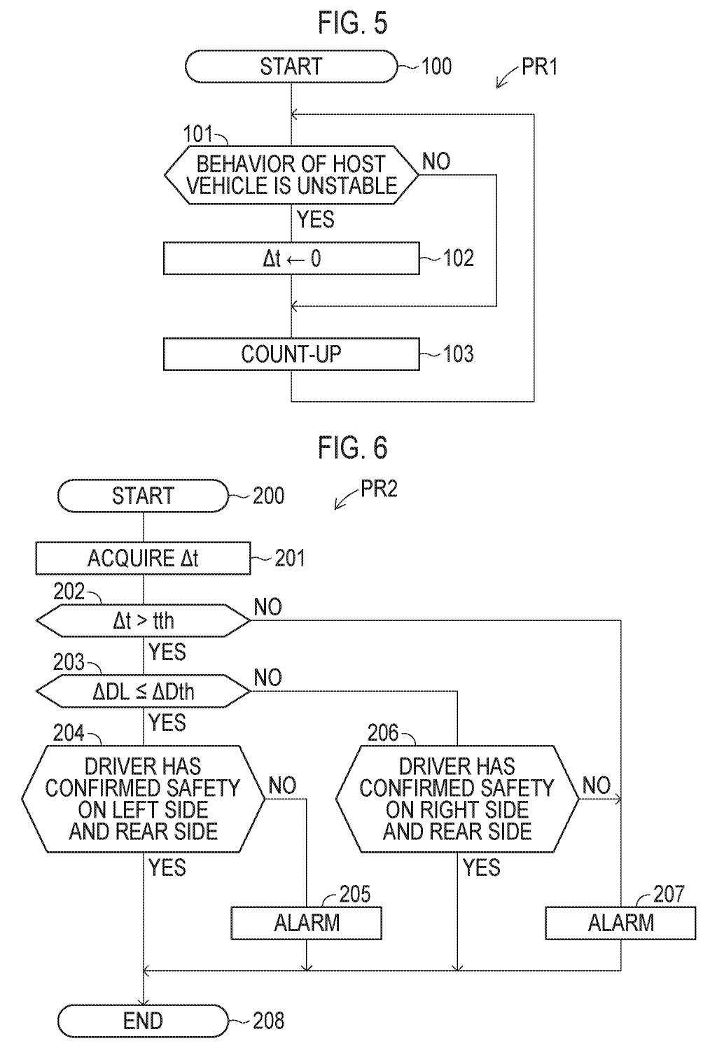

Next, programs PR1, PR2 executed by the CPU 10a (hereinafter, simply referred to as a “CPU”) to implement the functions (the function of skipping the alarm in a case where the predetermined condition is satisfied) of the driving assistance device 1 will be described with reference to FIGS. 5 and 6. The CPU starts the execution of the program PR1 in a case where the ignition switch of the host vehicle transitions from the off state to the on state. In addition, the CPU starts the execution of the program PR2 in a case where the condition X is satisfied.

### Program PR1

The CPU starts the execution of the program PR1 from step 100 and proceeds to step 101.

In step 101, the CPU determines whether the behavior of the host vehicle is unstable (whether at least one of the condition Y1 or the condition Y2 is satisfied). In a case where the CPU determines that the behavior of the host vehicle is unstable (101: Yes), the CPU proceeds to step 102. On the other hand, in a case where the CPU determines that the behavior of the host vehicle is not unstable (101: No), the CPU proceeds to step 103.

In step 102, the CPU resets the output (time Δt) of the timer 10d to “0”. Next, the CPU proceeds to step 103.

In step 103, the CPU operates the timer 10d as a count-up timer. Next, the CPU returns to step 101. In a case where the timer 10d is already operating as a count-up timer at the time when the CPU proceeds to step 103, the CPU returns to step 101 while maintaining the operating state of the timer 10d.

### Program PR2

The CPU starts the execution of the program PR2 from step 200 and proceeds to step 201.

In step 201, the CPU acquires the output (time Δt) of the timer 10d. Next, the CPU proceeds to step 202.

In step 202, the CPU determines whether the time Δt exceeds the threshold value Δtth. In a case where the CPU determines that the time Δt exceeds the threshold value Δtth (202: Yes), the CPU proceeds to step 203. On the other hand, in a case where the CPU determines that the time Δt does not exceed the threshold value Δtth (202: No), the CPU proceeds to step 207.

In step 203, the CPU determines whether the lateral distance ΔDL is equal to or less than the threshold value ΔDth (whether the host vehicle approaches the left end of the lane L). In a case where the CPU determines that the lateral distance ΔDL is equal to or less than the threshold value ΔDth (203: Yes), the CPU proceeds to step 204. On the other hand, in a case where the CPU determines that the lateral distance ΔDL is not equal to or less than the threshold value ΔDth (203: No), the CPU proceeds to step 206. As described above, the CPU executes the program PR2 in a case where the condition X (ΔDL ≤ ΔDth or ΔDR ≤ ΔDth) is satisfied. Therefore, in step 203, in a case where the CPU determines that the lateral distance ΔDL is not equal to or less than the threshold value ΔDth, the lateral distance ΔDR is equal to or less than the threshold value ΔDth. That is, in this case, the host vehicle approaches the right end of the lane L.

In step 204, the CPU determines whether the driver has confirmed the safety on the left side and the rear side. That is, the CPU determines whether the gaze of the driver specified by the gaze data is included in each of the angle ranges RMC, RML, and RBL at least once in the period T2. In a case where the CPU determines that the driver has confirmed the safety on the left side and the rear side (204: Yes), the CPU proceeds to step 208. That is, in this case, the CPU skips alarm processing (step 205) described below. On the other hand, in a case where the CPU determines that the driver has not confirmed the safety on the left side (204: No), the CPU proceeds to step 205.

In step 205, the CPU executes the alarm processing. That is, the CPU controls the notification device 30 to provide the predetermined information (image and voice) indicating that the host vehicle is likely to depart from the lane L to the driver. Next, the CPU proceeds to step 208.

In step 206, the CPU determines whether the driver has confirmed the safety on the right side and the rear side. That is, the CPU determines whether the gaze of the driver specified by the gaze data is included in each of the angle ranges RMC, RMR, and RBR at least once in the period T2. In a case where the CPU determines that the driver has confirmed the safety on the right side and the rear side (206: Yes), the CPU proceeds to step 208. That is, in this case, the CPU skips alarm processing (step 207) described below. On the other hand, in a case where the CPU determines that the driver has not confirmed the safety on the right side and the rear side (206: No), the CPU proceeds to step 207.

In step 207, the CPU executes the same alarm processing as in step 205. Next, the CPU proceeds to step 208.

In step 208, the CPU ends the execution of the program PR2.

### Effect

The ECU 10 of the driving assistance device 1 according to the present embodiment executes the alarm processing in a case where the host vehicle is likely to depart from the lane L in which the host vehicle is traveling. However, the ECU 10 skips the alarm processing in a case where a certain amount of time has elapsed after the behavior of the host vehicle has been stabilized even in a situation where the host vehicle is likely to depart from the lane L, and the driver has confirmed the safety in the vicinity. That is, in a situation where the behavior of the host vehicle is unstable, immediately after the situation, and a situation where the driver has not confirmed the safety in the vicinity, the ECU 10 executes the alarm processing as a matter of principle. Therefore, according to the driving assistance device 1 according to the present embodiment, the safety of the host vehicle and the vicinity thereof can be maintained at a high level in a situation where it is highly likely that the driver does not intend for the host vehicle to depart from the lane L.

### Modification 1

In the above-described embodiment, the ECU 10 measures the time Δt elapsed from the point in time at which the behavior of the host vehicle has been stabilized by resetting the timer 10d each time the condition Y1 and/or the condition Y2 is determined to be satisfied. Then, the ECU 10 determines that a sufficient amount of time has elapsed after the behavior of the host vehicle has been stabilized in a case where the time Δt exceeds the threshold value Δtth at the point in time t0 at which the condition X is satisfied. Instead of this, the ECU 10 may execute the following process. That is, the ECU 10 may execute the following process at the point in time t0 at which the condition X is satisfied. That is, the ECU 10 extracts the steering angle θ at each time in a predetermined length (for example, 10 minutes) period T3 immediately before the current point in time (that is, the point in time t0) by referring to the steering angle history data. Next, the ECU 10 determines whether the following conditions Y3 and/or Y4 are satisfied based on the time series of the extracted steering angle θ.

Condition Y3: the number of times N of a reversal of a movement direction of the host vehicle in the lateral direction in the period T3 exceeds a threshold value Nth.

Condition Y4: a lateral movement speed spy of the host vehicle exceeds a threshold value spyth in the period T3.

Then, the ECU 10 determines that a sufficient amount of time has elapsed after the behavior of the host vehicle has been stabilized in a case where the condition Y3 and the condition Y4 are not satisfied at the point in time t0.

### Modification 2

In the above-described embodiment, the ECU 10 determines whether the behavior of the host vehicle is unstable based on the steering angle θ. Instead of this (or in addition), the ECU 10 may determine whether the behavior of the host vehicle is unstable based on the yaw rate. In addition, the ECU 10 may determine whether the behavior of the host vehicle is unstable based on the speed sp0 (depression depth of an accelerator pedal and/or a brake pedal) of the host vehicle instead of (or in addition to) the steering angle θ. For example, the ECU 10 may determine that the behavior of the host vehicle is unstable in a case where the number of repetitions of the speed change in which the speed sp0 exceeds a predetermined upper limit value and then falls below a predetermined lower limit value in the period T1 (period T3) exceeds the threshold value. In addition, for example, the ECU 10 may determine that the behavior of the host vehicle is unstable in a case where a rate of change (acceleration and deceleration) of the speed sp0 exceeds the threshold value in the period T1 (period T3).

### Modification 3

The ECU 10 may be configured to detect an operation state (blinking/off) of the direction indicator of the host vehicle and adopt the detection result as one of the conditions for skipping the alarm processing. That is, the ECU 10 skips the above-described alarm processing in the following case at the point in time t0, that is, a case where the ECU 10 determines that the left side direction indicator is blinking, the lateral distance ΔDL is equal to or less than the threshold value ΔDth, a sufficient amount of time has elapsed after the behavior of the host vehicle has been stabilized, and the driver has confirmed the safety on the left side and the rear side. In addition, the ECU 10 skips the above-described alarm processing in the following case, that is, a case where the ECU 10 determines that the right side direction indicator is blinking, the lateral distance ΔDR is equal to or less than the threshold value ΔDth, a sufficient amount of time has elapsed after the behavior of the host vehicle has been stabilized, and the driver has confirmed the safety on the right side and the rear side (the condition ZR is satisfied) at the point in time t0.

What is claimed is:

1. A driving assistance device comprising:
a peripheral sensor configured to acquire target information that is information on a target located around a host vehicle;
a vehicle sensor configured to acquire vehicle information that is information on behavior of the host vehicle; and
a processor configured to execute, based on the target information and the vehicle information, alarm processing of controlling a notification device of the host vehicle to issue a predetermined alarm to a driver of the host vehicle in a case where a first condition for determining that there is a high possibility that the host vehicle departs from a lane in which the host vehicle is traveling is satisfied, wherein
the driving assistance device further includes a driver sensor configured to acquire gaze information that is information on gaze of the driver, and
the processor is configured to execute, at a first point in time at which the first condition is satisfied, skip processing of skipping the alarm processing in a case where
the processor acquires an elapsed time from a point in time at which a second condition for determining, based on a history of either or both of the target information and the vehicle information, that the behavior of the host vehicle is unstable has been satisfied most recently, and the elapsed time exceeds a threshold value, and
a third condition for determining, based on a history of the gaze information, that the driver has visually confirmed safety in a surrounding area within a predetermined period immediately before the first point in time is satisfied.

2. The driving assistance device according to claim 1, wherein the processor is configured to determine, based on the gaze information, that the third condition is satisfied in a case where the processor detects that a first safety confirmation has been performed by the driver visually checking a predetermined mirror of the host vehicle and a second safety confirmation has been performed by the driver directly visually checking a blind spot region that is a region that is not reflected in the mirror.

3. The driving assistance device according to claim 1, wherein:
the vehicle sensor includes a driving operation sensor configured to output a value corresponding to a driving operation, the vehicle sensor being provided in a driving operation device; and
the processor is configured to determine, based on a history of the value acquired from the driving operation sensor, that the second condition is satisfied in a case where a rate of change of the value exceeds a predetermined value.

4. The driving assistance device according to claim 1, wherein the processor is configured to determine, based on either or both of the target information and the vehicle information, that the second condition is satisfied in a case where the number of times that a lateral movement direction of the host vehicle is reversed within a predetermined period immediately before a current point in time exceeds a predetermined number of times.
